(19) United States
(12) Patent Application Publication
(10) Pub. No.: US 2011/0190448 A1
(43) Pub. Date: Aug. 4, 2011

(54) POLYPROPYLENE-POLYLACTIC ACID COMPOSITES

(75) Inventors: Chae Hwan Hong, Ansan (KR); Do Suck Han, Seongnam (KR)

(73) Assignee: HYUNDAI MOTOR COMPANY, Seoul (KR)

(21) Appl. No.: 12/752,887

(22) Filed: Apr. 1, 2010

(30) Foreign Application Priority Data
Feb. 1, 2010 (KR) 10-2010-0009245

(51) Int. Cl. C08L 23/12

(52) U.S. Cl. 525/69

(57) ABSTRACT

Disclosed is a polypropylene-polylactic acid composite composition, in which a maleic anhydride grafted ethylene-octene copolymer is included as a compatiblilizer. Since the provided polylactic acid composite composition includes the biomaterial polylactic acid resin, it is capable of effectively reducing carbon dioxide emission. Hence, it goes along with the low-carbon, green growth initiative. Further, with improved mechanical strength and heat resistance, it is usefully applicable to automotive interiors/exteriors, construction interiors, etc.

### CROSS-REFERENCE(S) TO RELATED APPLICATIONS

This application claims under 35 U.S.C. §119(a) priority of Korean Patent Application No. 10-2010-0009245, filed on Feb. 1, 2010, which is incorporated herein by reference.

### BACKGROUND OF THE INVENTION

1. Field of the Invention

The present invention relates to a polypropylene-polylactic acid composite having superior heat resistance and mechanical strength and being usefully applicable to automotive interiors/exteriors, construction interiors, etc.

2. Description of Related Art

Fossil fuel resources, particularly petroleum resources have been used in many fields of industry. Since the amount of petroleum resources are finite, research has been focused on developing alternative energy sources. One of the alternative energy sources that have been proposed is a biomass polymer derived from a plant source such as corn, beans, sugarcane and woods. Of the biomass polymers, polylactic acid resin has been proposed as material for manufacturing industrial objects including automotive parts.

One of the problems with polylactic acid resin is its physical property such as low heat resistance and impact resistance, which causes industrial applications to be limited. Methods that have been proposed to improve the heat resistance and impact resistance of polylactic acid resin was to blend polylactic acid resin with polypropylene resin by using a compatibilizer, as disclosed in, for Japanese Patent Application Publication Nos. 2009-096892, 2008-081585, and 2008-111043. More specifically, in these methods, a maleic anhydride grafted amorphous polypropylene, a maleic anhydride grafted ethylene-propylene copolymer, or an amino modified elastomer is used as a compatibilizer. The resulting composites, however, still have physical properties insufficient for application to automotive interior and exterior parts, construction interiors, etc.

The above information disclosed in this Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a composite composition including a polypropylene resin, a polylactic acid resin and a maleic anhydride grafted ethylene-octene copolymer resin. The polypropylene-polylactic acid composite composition according to the present invention is applicable to existing polypropylene injection molding processes and is applicable to automotive interiors/exteriors, construction interiors, etc.

The above features and advantages of the present invention will be apparent from or are set forth in more detail in the accompanying drawings, which are incorporated in and form a part of this specification, and the following Detailed Description, which together serve to explain by way of example the principles of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWING

The above and other objects, features and advantages of the present invention will become apparent from the following description of preferred embodiments given in conjunction with the accompanying drawing, in which:

FIG. 1 schematically shows a principle by which a polypropylene resin is made compatible with a polylactic acid resin.

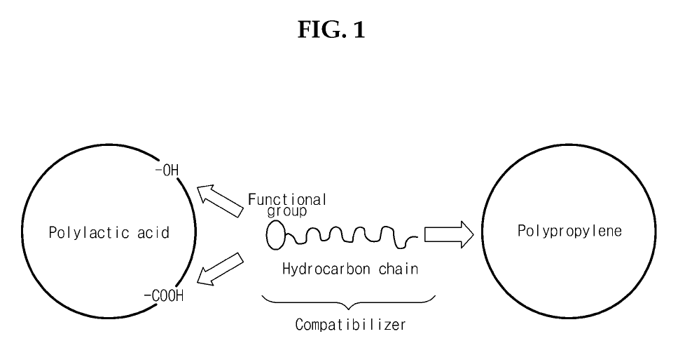

### DETAILED DESCRIPTION OF EMBODIMENTS

The advantages, features and aspects of the invention will become apparent from the following description of the embodiments with reference to the accompanying drawings, which is set forth hereinbelow.

The present invention provides a polypropylene-polylactic acid composite composition comprising a polypropylene resin, a polylactic acid resin and a maleic anhydride grafted ethylene-octene copolymer resin.

The polypropylene resin, which is one of commonly used plastic resins, is easily available, inexpensive, prepared simply, very light because of low specific gravity and strong, has low thermal conductivity, does not absorb water, and has superior elasticity, chemical resistance and processability. Since it is a recyclable thermoplastic resin, its use has continued to increase.

In the present invention, one selected from a propylene homopolymer, a propylene random copolymer and a propylene block copolymer may be used. Preferably, one having a melt index (MI) of 0.5 to 30 g/10 min (ASTM D 1238, 230° C.), more preferably 1.5 to 20 g/10 min, is used. If the melt index is too low, processability of the composite may be degraded because of excessively high melt viscosity. Meanwhile, if the melt index is too high, mechanical property may not be improved. Preferably, the polypropylene resin is used in an amount of 65 to 70 wt % based on 100 wt % of the composite composition. If it is used less than 65 wt %, mechanical property may be degraded because of shortage of the polypropylene resin, which is used as a major matrix material. Meanwhile, if it is used greater than 70 wt %, the content of the biomaterial polylactic acid is relatively low. Therefore, it is preferred that the above range be maintained.

The polylactic acid resin is prepared from polymerization of a lactic acid monomer. Lactic acid exists as either L- or D-lactic acid which have different optical activity. Lactic acid can be synthesized chemically from fossil fuels such as coal, petroleum, natural gas, etc., or produced from carbohydrate fermentation of plant-derived sources such as corn starch, potato starch, and sugarcane juice. Whereas the lactic acid synthesized chemically from fossil fuels is obtained as a racemic mixture of L- and D-lactic acid, the fermentation product is 99.5 wt % or more of L-lactic acid. Thus, the fermentation of plant-derived sources is preferred. Also, in the present invention, a natural material synthesized from biomass, preferably having a molecular weight of 80,000 to 150,000 g/mol, is preferably used. If the molecular weight is smaller than 80,000 g/mol, mechanical strength may be insufficient. Meanwhile, if it is greater than 150,000 g/mol, uniform dispersion may not be attained because of an excessively high melting point. Preferably, the polylactic acid resin is used in an amount of 15 to 25 wt %. If it is used less than 15 wt %, the significance of using the environment-friendly biomaterial as compared to existing petroleum-based materials is tarnished and mechanical property may be degraded because the amount of the material that binds with the maleic anhydride grafted ethylene-octene copolymer decreases. Meanwhile, if it is used more than 25 wt %, mechanical property may decrease because of relatively small content of the polypropylene resin.

The maleic anhydride grafted ethylene-octene copolymer resin is used as a compatibilizer of the polypropylene resin and the polylactic acid resin which are incompatible because of different polarity. It serves as a dispersant which uniformly disperses the particles of the polylactic acid resin in which a carbon nanotube is dispersed by in-situ polymerization in the polypropylene resin to micro scale and as a crosslinker which induces interfacial adhesion between the polypropylene resin and the polylactic acid resin in which a carbon nanotube is dispersed by in-situ polymerization and thereby improves mechanical property. Preferably, the maleic anhydride grafted ethylene-octene copolymer has a maleic anhydride graft ratio of 0.5 to 1.0 wt %. If the graft ratio is below 0.5 wt %, the polylactic acid resin may not be uniformly dispersed because of low polarity. Meanwhile, if it exceeds 1.0 wt %, dispersibility of the polylactic acid resin may decrease because of excessively high melt viscosity. Therefore, it is preferred that the above range be maintained. Preferably, the maleic anhydride grafted ethylene-octene copolymer is used in an amount of 5 to 20 wt % based on 100 wt % of the composition. If it is used less than 5 wt %, impact strength of the composition may be degraded because the polylactic acid resin is not uniformly dispersed. And, if is used greater than 20 wt %, mechanical strength may not be improved. Therefore, it is preferred that the above range be maintained.

The polypropylene-polylactic acid composite composition of the present invention may be formed into automotive interiors/exteriors or construction interiors as follows.

First, 65 to 70 wt % of a polypropylene resin, 15 to 25 wt % of a polylactic acid resin and 5 to 20 wt % of a maleic anhydride grafted ethylene-octene copolymer are completely mixed using a mixing machine such as a blender or hopper. Then, the mixed material is melt extruded using an extruder into a pellet. The extruded pellet is heated to 200 to 220° C. and then injection molded in a mold of 30 to 50° C. to obtain a product with a desirable shape.

The polypropylene-polylactic acid composite composition according to the present invention which comprises the biomaterial polylactic acid up to 25 wt % is renewable after use, and, because of superior heat resistance and mechanical property including impact strength, is usefully applicable to automotive interiors/exteriors such as dash outer silencer, dash inner silencer, hood silencer, door pad, door trim, headliner, package tray, trunk mat, construction interiors, etc.

### EXAMPLES

The examples and experiments will now be described. The following examples are for illustrative purposes only and not intended to limit the scope of the present invention.

### Examples 1 and 2

A polypropylene resin, a polylactic acid resin and a maleic anhydride grafted ethylene-octene copolymer resin were mixed in dry state and, after adding to a twin screw extruder, melt mixed at 210° C., i.e., above the melting point, to prepare composite compositions according to the present invention. The polylactic acid resin was dispersed into the melt polypropylene resin and maleic anhydride grafted ethylene-octene copolymer. The composition is given in Table 1.

### Comparative Examples 1 to 4

Composite compositions for comparison with those according to Examples 1 and 2 were prepared in the same manner as in Example 2, except for using a maleic anhydride grafted amorphous polypropylene resin (Comparative Example 1), a maleic anhydride grafted crystalline polypropylene resin (Comparative Example 2), a maleic anhydride grafted ethylene-propylene copolymer resin (Comparative Example 3) and an amino modified styrene-ethylene-butylene-styrene block copolymer resin (Comparative Example 4), respectively, instead of the maleic anhydride grafted ethylene-octene copolymer resin. The composition is given in Table 1.

TABLE 1

| | |
|---|---|
| Examples | Comparative |
| (wt %) | Examples (wt %) |

| | 1 | 2 | 1 | 2 | 3 | 4 |
|---|---|---|---|---|---|---|
| A | 65 | 70 | 70 | 70 | 70 | 70 |
| B | 15 | 25 | 25 | 25 | 25 | 25 |
| C-1 | 20 | 5 | — | — | — | — |
| C-2 | — | — | 5 | — | — | — |
| C-3 | — | — | — | 5 | — | — |
| C-4 | — | — | — | — | 5 | — |
| C-5 | — | — | — | — | — | 5 |

A: Polypropylene random copolymer resin (R724, LG-Caltex)
B: Polylactic acid resin (Nature Works)
C-1: Maleic anhydride grafted ethylene-octene copolymer resin (Aldrich)
C-2: Maleic anhydride grafted amorphous polypropylene resin (Tuf-selen T4535MA, Sumitomo Chemical)
C-3: Maleic anhydride grafted crystalline polypropylene resin (Umex 1010, Sanyo Chemical Industries)
C-4: Maleic anhydride grafted ethylene-propylene copolymer resin (MP0620, Mitsui Chemical)
C-5: Amino modified styrene-ethylene-butylene-styrene block copolymer resin (Dynaron 8630P, JSR)

### Test Example

### Measurement of Physical Properties

In order to measure the mechanical properties of the composite compositions prepared in Examples 1 and 2 and Comparative Examples 1 to 4, test specimens were prepared by injection molding and physical properties were measured according to ASTM D 638, ASTM D 256, ASTM D 790 and ASTM D 648. The result is given in Table 2. The specimen for tensile property measurement was dumbbell-shaped and that for impact strength measurement had notches formed thereon.

1) Tensile Property

A test specimen was prepared according to ASTM D 638 (Standard Test Method for Tensile Properties of Plastics) and tensile strength, elongation and tensile modulus were measured using a universal testing machine.

2) Impact Strength

A test specimen was prepared according to ASTM D 256 (Standard Test Methods for Determining the Izod Pendulum Impact Resistance of Plastics) and impact strength was measured using an Izod impact tester.

3) Flexural Modulus

A test specimen was prepared according to ASTM D 790 (Standard Test Methods for Flexural Properties of Unreinforced and Reinforced Plastics and Electrical Insulating Materials) and flexural modulus was measured using a universal testing machine.

4) Heat Resistance

A test specimen was prepared according to ASTM D 648 (Standard Test Method for Deflection Temperature of Plastics Under Flexural Load in the Edgewise Position) and heat resistance was measured using a universal testing machine.

TABLE 2

| | Examples | | Comparative Examples | | | |
|---|---|---|---|---|---|---|
| | 1 | 2 | 1 | 2 | 3 | 4 |
| Tensile strength (MPa) | 281 | 280 | 150 | 130 | 120 | 130 |
| Elongation (%) | 490 | 450 | 150 | 183 | 190 | 170 |
| Tensile modulus | 1500 | 1450 | 560 | 580 | 570 | 550 |
| (MPa) | | | | | | |
| Impact strength | 18 | 19 | 17 | 6 | 5 | 4 |
| (kJ/m²) | | | | | | |
| Flexural modulus | 12000 | 12100 | 8000 | 8200 | 11900 | 9100 |
| (MPa) | | | | | | |
| Heat resistance (° C.) | 119 | 118 | 90 | 92 | 115 | 90 |

As shown in Table 2, Comparative Example 1, wherein a maleic anhydride grafted amorphous polypropylene resin was used as a compatibilizer, exhibited good impact strength but low tensile property. Comparative Example 3, wherein a maleic anhydride grafted ethylene-propylene copolymer resin was used, showed superior heat resistance and flexural modulus but impact strength and tensile property were insufficient to be used for automotive interiors and exteriors. When compared with Comparative Example 4, wherein an amino modified elastomer was used, the polypropylene-polylactic acid composite composition of the present invention, wherein a maleic anhydride grafted ethylene-octene copolymer resin was used, showed better mechanical strength and heat resistance.

In conclusion, the polypropylene-polylactic acid composite compositions of the present invention have superior impact strength (≧18 kJ/m²) and heat resistance (≧110° C.) satisfying the requirements of automotive interiors and exteriors as well as better tensile property as compared to existing polylactic acid composite compositions. Therefore, it is usefully applicable to automotive interiors/exteriors such as dash outer silencer, dash inner silencer, hood silencer, door pad, door trim, headliner, package tray, trunk mat, construction interiors, etc.

While the present invention has been described with respect to the specific embodiments, it will be apparent to those skilled in the art that various changes and modifications may be made without departing from the spirit and scope of the invention as defined in the following claims.

What is claimed is:

1. A polypropylene-polylactic acid composite composition comprising a polypropylene resin, a polylactic acid resin and a maleic anhydride grafted ethylene-octene copolymer resin.

2. The polypropylene-polylactic acid composite composition according to claim 1, wherein the polypropylene resin is selected from a propylene homopolymer, a propylene random copolymer and a propylene block copolymer and has a melt index (MI) of 0.5 to 30 g/10 min (ASTM D 1238, 230° C.).

3. The polypropylene-polylactic acid composite composition according to claim 1, wherein the polylactic acid resin is a natural material synthesized from biomass and has a molecular weight of 80,000 to 150,000 g/mol.

4. The polypropylene-polylactic acid composite composition according to claim 1, wherein the maleic anhydride grafted ethylene-octene copolymer resin has a maleic anhydride graft ratio of 0.5 to 1.0 wt %.

5. The polypropylene-polylactic acid composite composition according to claim 1, which comprises:
65 to 70 wt % of the polypropylene resin;
15 to 25 wt % of the polylactic acid resin; and
5 to 20 wt % of the maleic anhydride grafted ethylene-octene copolymer resin.

6. The polypropylene-polylactic acid composite composition according to claim 5, wherein the polypropylene resin is selected from a propylene homopolymer, a propylene random copolymer and a propylene block copolymer and has a melt index (MI) of 0.5 to 30 g/10 min (ASTM D 1238, 230° C.).

7. The polypropylene-polylactic acid composite composition according to claim 5, wherein the polylactic acid resin is a natural material synthesized from biomass and has a molecular weight of 80,000 to 150,000 g/mol.

8. The polypropylene-polylactic acid composite composition according to claim 5, wherein the maleic anhydride grafted ethylene-octene copolymer resin has a maleic anhydride graft ratio of 0.5 to 1.0 wt %.
